(19) United States
(12) Patent Application Publication
(10) Pub. No.: US 2020/0305653 A1
(43) Pub. Date: Oct. 1, 2020

(54) FOOT SCRUBBER SHOWER BRUSH

(71) Applicant: Barry Spencer, Livermore, CA (US)

(72) Inventor: Barry Spencer, Livermore, CA (US)

(21) Appl. No.: 16/364,281

(22) Filed: Mar. 26, 2019

(51) Int. Cl. A47K 7/02; B08B 1/00; A46B 5/00; A46B 9/02; A46B 9/08; A46B 15/00

(52) U.S. Cl. CPC A47K 7/026; B08B 1/002; A46B 5/00; A46B 2200/1006; A46B 9/08; A46B 15/0097; A46B 9/025

(57) ABSTRACT

The foot scrubber shower brush is a personal care implement that may be placed on a floor and may be adapted to clean a foot without requiring a user to bend down. As a non-limiting example, the floor may be the bottom surface of a shower stall. The foot scrubber shower brush is adapted to clean a right foot by placing a left foot on the left side platform to hold the foot scrubber shower brush in place while the right foot is brushed. The foot scrubber shower brush is adapted to clean the left foot by placing the right foot on the right side platform to hold the foot scrubber shower brush in place while the left foot is brushed.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the fields of shower accessories, more specifically, a foot scrubber shower brush.

### SUMMARY OF INVENTION

The foot scrubber shower brush is a personal care implement that may be placed on a floor and may be adapted to clean a foot without requiring a user to bend down. As a non-limiting example, the floor may be the bottom surface of a shower stall. The foot scrubber shower brush is adapted to clean a right foot by placing a left foot on the left side platform to hold the foot scrubber shower brush in place while the right foot is brushed. The foot scrubber shower brush is adapted to clean the left foot by placing the right foot on the right side platform to hold the foot scrubber shower brush in place while the left foot is brushed.

An object of the invention is to clean a human foot.

Another object of the invention is to provide bottom bristles and top bristles for cleaning a foot.

A further object of the invention is to provide a left side platform and a right side platform, one of which may be held down with one foot while the other foot is brushed.

Yet another object of the invention is to provide a tether hole for lifting or securing the invention in place.

These together with additional objects, features and advantages of the foot scrubber shower brush will be readily apparent to those of ordinary skill in the art upon reading the following detailed description of the presently preferred, but nonetheless illustrative, embodiments when taken in conjunction with the accompanying drawings.

In this respect, before explaining the current embodiments of the foot scrubber shower brush in detail, it is to be understood that the foot scrubber shower brush is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the foot scrubber shower brush.

It is therefore important that the claims be regarded as including such equivalent construction insofar as they do not depart from the spirit and scope of the foot scrubber shower brush. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a bottom view of an embodiment of the disclosure.

FIG. 3 is a top view of an embodiment of the disclosure.

FIG. 4 is a rear view of an embodiment of the disclosure.

FIG. 5 is a side view of an embodiment of the disclosure.

FIG. 6 is an in-use detail view of an embodiment of the disclosure illustrating cleaning the left foot.

FIG. 7 is an in-use detail view of an embodiment of the disclosure illustrating cleaning the right foot.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

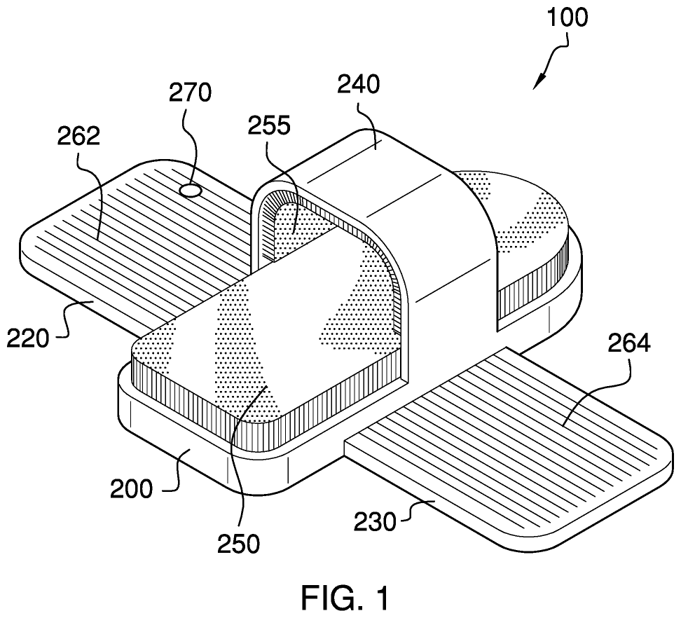

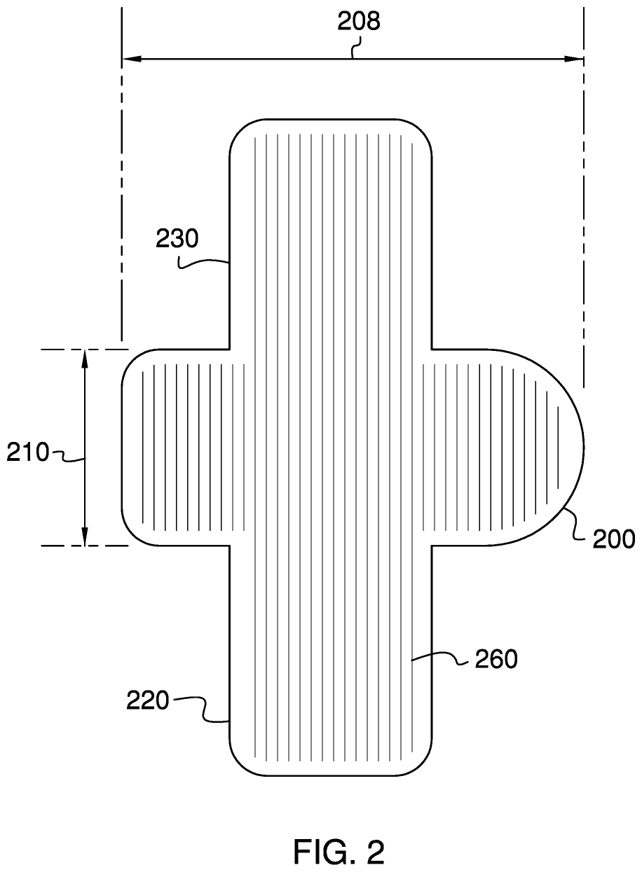

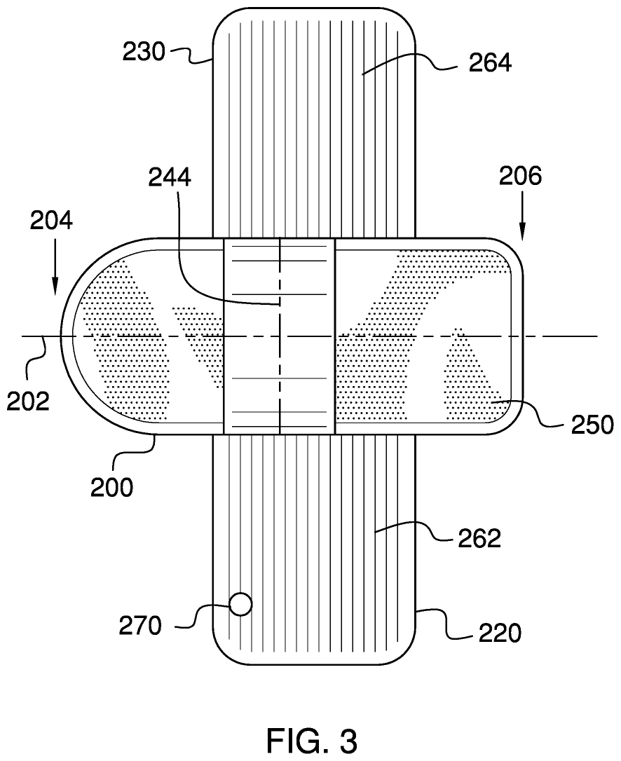

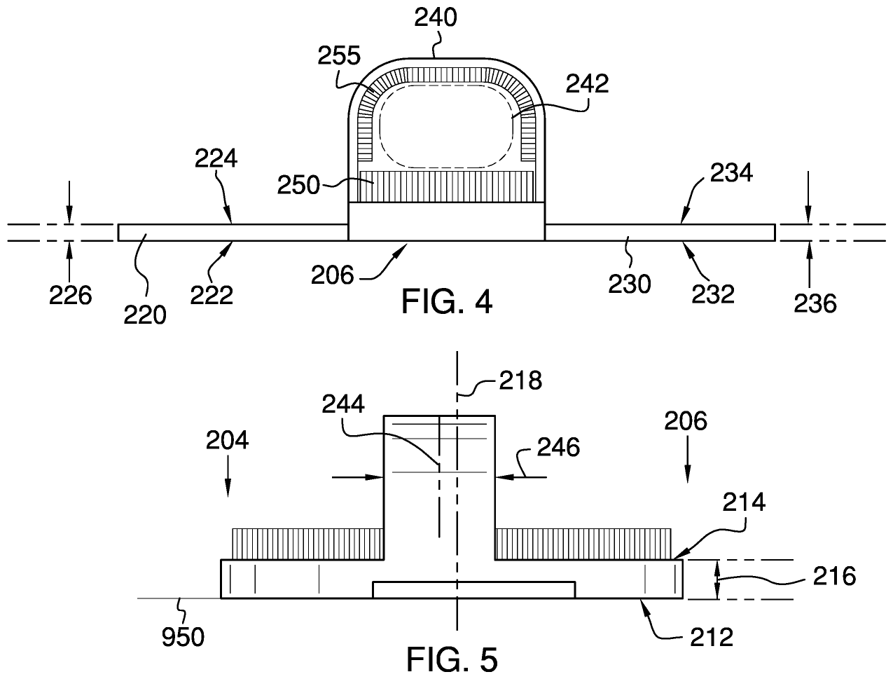

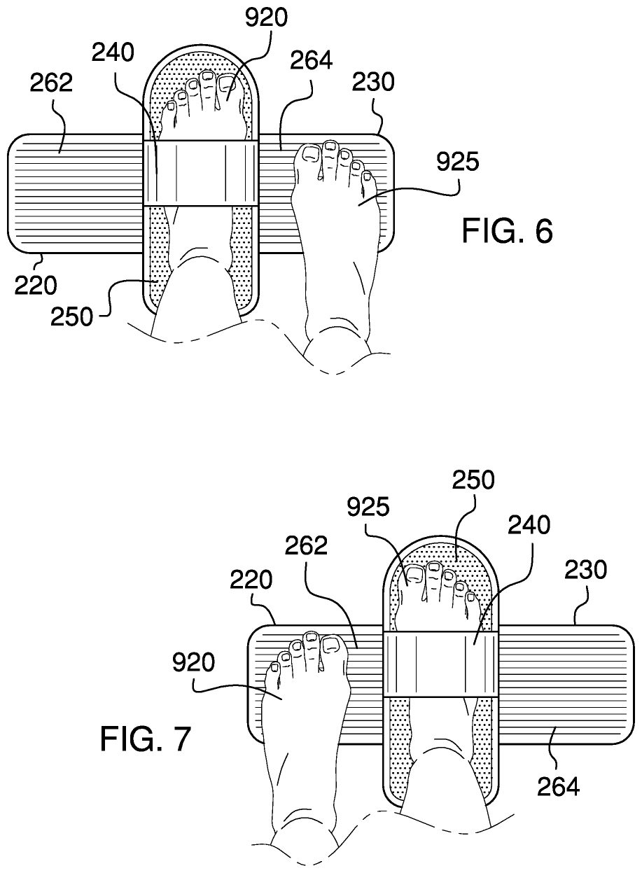

Detailed reference will now be made to a first potential embodiment of the disclosure, which is illustrated in FIGS. 1 through 7.

The foot scrubber shower brush 100 (hereinafter invention) comprises a foot support 200, a left side platform 220, a right side platform 230,an arch 240, bottom bristles 250, and top bristles 255. The invention 100 may be a personal care implement that may be adapted to be placed on a floor 950 and used to clean a foot without requiring a user to bend down. As a non-limiting example, the floor 950 may be the bottom surface of a shower stall. The invention 100 is adapted to clean a right foot 925 by placing a left foot 920 on the left side platform 220 to hold the invention 100 in place while the right foot 925 is brushed. The invention 100 is adapted to clean the left foot 920 by placing the right foot 925 on the right side platform 230 to hold the invention 100 in place while the left foot 920 is brushed.

The foot support 200 may be an oblong shape and made from a rigid or semi-rigid material. A longitudinal axis 202 of the foot support 200 may run from a toe end 204 of the foot support 200 to a heel end 206 of the foot support 200. A length 208 of the foot support 200 as measured along the longitudinal axis 202 from the toe end 204 to the heel end 206 may be adapted to be at least as long as a human, adult foot. A width 210 of the foot support 200 as measured from one side to the opposite side along a lateral, horizontally oriented line that is perpendicular to the longitudinal axis 202 may be adapted to be at least as wide as the human, adult foot. The foot support 200 may be oriented horizontally. A foot support bottom surface 212 may rest on the floor 950 when the invention 100 is in use. The foot support bottom surface 212 and a foot support top surface 214 may define a foot support thickness 216.

The foot support 200 may further comprise the bottom bristles 250. The bottom bristles 250 may be a plurality of semi-rigid filaments that are adapted to brush debris from the foot. The bottom end of each of the bottom bristles 250 may couple to the foot support top surface 214. Each of the bottom bristles 250 may rise from the foot support 200 in a vertical orientation.

The left side platform 220 may be a lateral extension of the left side of the foot support 200. A left side bottom surface 222 may be coplanar with the foot support bottom surface 212 and may rest on the floor 950 when the invention 100 is in use. A left side thickness 226 as measured vertically between the left side bottom surface 222 to a left side top surface 224 may be less than the foot support thickness 216.

The left side top surface 224 may comprise an upper left non-skid finish 262. The upper left non-skid finish 262 may be a coating or texturing of the left side top surface 224 that increases the friction of the top of the left side platform 220.

The right side platform 230 may be a lateral extension of the right side of the foot support 200. A right side bottom surface 232 may be coplanar with the foot support bottom surface 212 and may rest on the floor 950 when the invention 100 is in use. A right side thickness 236 as measured vertically between the right side bottom surface 232 to a right side top surface 234 may be less than the foot support thickness 216.

The right side top surface 234 may comprise an upper right non-skid finish 264. The upper right non-skid finish 264 may be a coating or texturing of the right side top surface 234 that increases the friction of the top of the right side platform 230.

The foot support bottom surface 212, the left side bottom surface 222, and the right side bottom surface 232 may comprise a bottom non-slip surface 260. The bottom non-slip surface 260 may be a coating or texturing of the right side top surface 234 that increases the friction of the bottom of the invention 100.

In some embodiments, the left side thickness 226 may be the same as the right side thickness 236.

The arch 240 may be an inverted U-shaped structure extending laterally over the top of the foot support 200. The space between the arch 240 and the foot support 200 may define a foot aperture 242. An arch width 246 as measured in a toe-to-heel direction along a line parallel to the longitudinal axis 202 may be between ⅙ and ⅓ of the length 208 of the foot support 200.

The arch 240 may couple to the foot support 200 at the upper left side of the foot support 200 and at the upper right side of the foot support 200. In some embodiments, a lateral centerline 244 of the arch 240 may be shifted longitudinally towards the toe end 204 of the foot support 200 and may therefore pass between a vertical centerline 218 of the foot support 200 and the toe end 204 of the foot support 200.

The foot support 200, the left side platform 220, the right side platform 230, the arch 240, or combinations thereof may be made from a rigid or semi-rigid material. As non-limiting examples, the foot support 200, the left side platform 220, the right side platform 230, the arch 240, or combinations thereof may be made from plastic, foam resin, leather, natural or synthetic rubber, or combinations thereof.

The arch 240 may comprise the top bristles 255. The top bristles 255 may be a plurality of semi-rigid filaments that are adapted to brush debris from the foot. One end of each of the top bristles 255 may couple to the inside surface of the arch 240. Each of the top bristles 255 may extend away from the arch 240 towards the center of the foot aperture 242.

As non-limiting examples, the bottom bristles 250 and the top bristles 255 may be made from nylon, plastic, natural rubber, synthetic rubber, or combinations thereof.

In some embodiments, all of the bottom bristles 250 may be a uniform length. In some embodiments, all of the top bristles 255 may be a uniform length.

In some embodiments, the invention 100 may comprise one or more tether apertures 270. The one or more tether apertures 270 may be oriented from top to bottom on the left side platform 220, on the right side platform 230, or on both. The one or more tether apertures 270 may allow the invention 100 to be hung from a hook for drying or may be adapted to allow attachment of a tether for holding the invention 100 in place or for lifting the invention 100 without bending.

In use, the invention 100 may be placed on the floor 950 in a shower. The user may place the left foot 920 on the left side platform 220 to hold the invention 100 in place while cleaning the right foot 925. The user may place the right foot 925 into the foot aperture 242 and may rub the right foot 925 forward and backward against the bottom bristles 250 and the top bristles 255 to clean the right foot 925. The user may then place the right foot 925 on the right side platform 230 to hold the invention 100 in place while cleaning the left foot 920. The user may place the left foot 920 into the foot aperture 242 and may rub the left foot 920 forward and backward against the bottom bristles 250 and the top bristles 255 to clean the left foot 920. When the invention 100 is no longer needed, it may be lifted using the tether attached to one of the one or more tether apertures 270 or hung to dry using one of the one or more tether apertures 270.

Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” refers to top and “lower” refers to the bottom. As a non-limiting example, the upper end of a vertical shaft is the top end of the vertical shaft.

As used in this disclosure, an “aperture” is an opening in a surface. Aperture may be synonymous with hole, slit, crack, gap, slot, or opening.

As used in this disclosure, an “arch” refers to a curved edge or surface that bounds a definable object or surface or that bounds a definable negative space.

As used in this disclosure, a “coating” refers to a substance that is applied to the exterior surface of an object such that the coating forms a new exterior surface of the object. A coating is commonly said to be formed as a layer. As a non-limiting example, pant is a common coating material.

As used herein, the words “couple”, “couples”, “coupled” or “coupling”, refer to connecting, either directly or indirectly, and does not necessarily imply a mechanical connection.

As used in this disclosure, “horizontal” is a directional term that refers to a direction that is perpendicular to the local force of gravity. Unless specifically noted in this disclosure, the horizontal direction is always perpendicular to the vertical direction.

As used herein, the words “invert”, “inverted”, or “inversion” refer to an object that has been turned inside out or upside down or to the act of turning an object inside out or upside down.

As used in this disclosure, the word “lateral” refers to the sides of an object or movement towards a side. Lateral directions are generally perpendicular to longitudinal directions. “Laterally” refers to movement in a lateral direction.

As used herein, the word “longitudinal” or “longitudinally” refers to a lengthwise or longest direction.

As used herein, “oblong” refers to an object that is elongated.

As used in this disclosure, “orientation” refers to the positioning and/or angular alignment of a first object relative to a second object or relative to a reference position or reference direction.

As used in this disclosure, “resilient” or “semi-rigid” refer to an object or material which will deform when a force is applied to it and which will return to its original shape when the deforming force is removed.

As used herein, “rigid” refers to an object or material which is inflexible. If a force is applied to a rigid object the rigid object does not bend or deform unless the force applied reaches the breaking point of the rigid object.

As used in this disclosure, a “tether” is a cord, line, webbing, or strap that is attached to an object to restrict movement.

As used in this disclosure, “vertical” refers to a direction that is parallel to the local force of gravity. Unless specifically noted in this disclosure, the vertical direction is always perpendicular to horizontal.

With respect to the above description, it is to be realized that the optimum dimensional relationship for the various components of the invention described above and in FIGS. 1 through 7, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A foot scrubber shower brush comprising:
a foot support, a left side platform, a right side platform, an arch, bottom bristles, and top bristles;
wherein the foot scrubber shower brush is a personal care implement that is adapted to be placed on a floor and used to clean a foot without requiring a user to bend down;
wherein the foot scrubber shower brush is adapted to clean a right foot by placing a left foot on the left side platform to hold the foot scrubber shower brush in place while the right foot is brushed;
wherein the foot scrubber shower brush is adapted to clean the left foot by placing the right foot on the right side platform to hold the foot scrubber shower brush in place while the left foot is brushed;
wherein the foot support is an oblong shape and made from a rigid or semi-rigid material;
wherein a longitudinal axis of the foot support runs from a toe end of the foot support to a heel end of the foot support;
wherein a length of the foot support as measured along the longitudinal axis from the toe end to the heel end is adapted to be at least as long as a human, adult foot;
wherein a width of the foot support, as measured from one side to the opposite side along a lateral horizontally oriented line that is perpendicular to the longitudinal axis, is adapted to be at least as wide as the human, adult foot;
wherein the foot support is oriented horizontally;
wherein a foot support bottom surface rests on the floor when the foot scrubber shower brush is in use;
wherein the foot support bottom surface and a foot support top surface define a foot support thickness;
wherein the foot support further comprises the bottom bristles;
wherein the bottom bristles are a plurality of semi-rigid filaments that are adapted to brush debris from the foot;
wherein the bottom end of each of the bottom bristles couples to the foot support top surface;
wherein each of the bottom bristles rises from the foot support in a vertical orientation;
wherein the left side platform is a lateral extension of the left side of the foot support;
wherein a left side bottom surface is coplanar with the foot support bottom surface and rests on the floor when the foot scrubber shower brush is in use;
wherein a left side thickness, as measured vertically between the left side bottom surface to a left side top surface, is less than the foot support thickness;
wherein the foot scrubber shower brush comprises one or more tether apertures.

2. (canceled)

3. (canceled)

4. (canceled)

5. The foot scrubber shower brush according to claim 1
wherein the left side top surface comprises an upper left non-skid finish;
wherein the upper left non-skid finish is a coating or texturing of the left side top surface that increases the friction of the top of the left side platform.

6. The foot scrubber shower brush according to claim 5
wherein the right side platform is a lateral extension of the right side of the foot support;
wherein a right side bottom surface is coplanar with the foot support bottom surface and rests on the floor when the foot scrubber shower brush is in use;
wherein a right side thickness as measured vertically between the right side bottom surface to a right side top surface is less than the foot support thickness.

7. The foot scrubber shower brush according to claim 6
wherein the right side top surface comprises an upper right non-skid finish;
wherein the upper right non-skid finish is a coating or texturing of the right side top surface that increases the friction of the top of the right side platform.

8. The foot scrubber shower brush according to claim 7
wherein the foot support bottom surface, the left side bottom surface, and the right side bottom surface comprise a bottom non-slip surface;
wherein the bottom non-slip surface is a coating or texturing of the right side top surface that increases the friction of the bottom of the foot scrubber shower brush.

9. The foot scrubber shower brush according to claim 8
wherein the left side thickness is the same as the right side thickness.

10. The foot scrubber shower brush according to claim 9
wherein the arch is an inverted U-shaped structure extending laterally over the top of the foot support;
wherein the space between the arch and the foot support defines a foot aperture.

11. The foot scrubber shower brush according to claim 10
wherein an arch width as measured in a toe-to-heel direction along a line parallel to the longitudinal axis is between ⅙ and ⅓ of the length of the foot support.

12. The foot scrubber shower brush according to claim 10
wherein the arch couples to the foot support at the upper left side of the foot support and at the upper right side of the foot support.

13. The foot scrubber shower brush according to claim 12
wherein a lateral centerline of the arch is shifted longitudinally towards the toe end of the foot support and therefore passes between a vertical centerline of the foot support and the toe end of the foot support.

14. The foot scrubber shower brush according to claim 13
wherein the foot support, the left side platform, the right side platform, the arch, or combinations thereof are made from a rigid or semi-rigid material.

15. The foot scrubber shower brush according to claim 14 p1 wherein the foot support, the left side platform, the right side platform, the arch, or combinations thereof are made from plastic, foam resin, leather, natural or synthetic rubber, or combinations thereof.

16. The foot scrubber shower brush according to claim 14
wherein the arch comprises the top bristles;
wherein the top bristles are a plurality of semi-rigid filaments that are adapted to brush debris from the foot;
wherein one end of each of the top bristles couples to the inside surface of the arch;
wherein each of the top bristles extends away from the arch towards the center of the foot aperture.

17. The foot scrubber shower brush according to claim 16
wherein the bottom bristles and the top bristles are made from nylon, plastic, natural rubber, synthetic rubber, or combinations thereof.

18. The foot scrubber shower brush according to claim 17
wherein all of the bottom bristles are a uniform length.

19. The foot scrubber shower brush according to claim 18
wherein all of the top bristles are a uniform length.

20. The foot scrubber shower brush according to claim 19
wherein the one or more tether apertures are oriented from top to bottom on the left side platform, on the right side platform, or on both.
wherein the one or more tether apertures allow the foot scrubber shower brush to be hung from a hook for drying or are adapted to allow attachment of a tether for holding the foot scrubber shower brush in place or for lifting the foot scrubber shower brush without bending.
